(19) United States
(12) Patent Application Publication
(10) Pub. No.: US 2025/0124501 A1
(43) Pub. Date: Apr. 17, 2025

(54) SYSTEM AND METHOD FOR CLIENT-SERVER MODEL INCLUDING AI-ENABLE PROCESSING FOR FINANCIAL PRODUCTS

(71) Applicant: Kyung Mi Kim, Los Angeles, CA (US)

(72) Inventor: Kyung Mi Kim, Los Angeles, CA (US)

(21) Appl. No.: 18/379,649

(22) Filed: Oct. 12, 2023

(51) Int. Cl. G06Q 40/02

(52) U.S. Cl. CPC G06Q 40/02

(57) ABSTRACT

A method implemented on an on-location premises evaluation device is disclosed. The method includes sending a prompt for a user to begin an on-location premises evaluation. The method includes, upon receiving confirmation from the user to being the evaluation, initiating the on-location premises evaluation. The method includes prompting the user to begin a walk-through of a structure associated with the premises. The method includes initiating a data recording process to capture at least one of a dimension measurement and imagery information of the premises. The method includes capturing at least one of a 3D model, a dimension measurement of the structure comprising at least one inside dimension and one outside dimension; at least one room quantity. The method includes capturing the recording data comprising at least one user attribute comprising at least one of a demographic and user preference attribute. The method includes sending the recorded data. The method includes receiving a response comprising at least one of a numerical assessed valuation.

### BACKGROUND

### Field

The present disclosure relates to mobile, server, and artificial intelligence-enable devices and methods catering to providers and users of the annuity products with mortgage rider options, and more particularly, but not exclusively, to devices and methods facilitating an improved process for the integration of mortgage and annuity products.

### Background

Financial services and products such as mortgages and annuities have presented various opportunities for income and wealth creation for individuals and for revenue and profits for the financial services companies. The provision of these financial services and products, however, has not kept pace with changes and innovations in technology. Currently, the existing products and services, including the many existing attributes and characteristics do not satisfy the needs of many prospective users. Furthermore, alternatives to building assets in response to changes in labor income due to technology and innovation must also be presented. Accordingly, there is a need for applying new techniques and technologies to the field of mortgage and annuity products and services.

Existing methods of saving for down payment on a house do not necessarily provide a positive rate of return, and therefore, there exists opportunities for improved returns on capital and investments by innovating annuity products having mortgage features. Through this innovation including a portfolio type investment that earns credit interest linked to the various equity indexes along with real estate, asset losses due to declines in real estate values may be alleviated through the diversification effect. This asset diversification is possible to protect individuals and financial services companies from hazards posed by illiquid real estate assets, thereby preventing delinquencies and foreclosures. As well, retirement income that requires a long-term duration to build in a similar manner as real estate assets can also be generated during the period of paying off the liability of mortgage. This will be a critical alternative to the problem of building basic assets according to changes in future labor income.

This innovation may inevitably lead to the integration of mortgage primary and secondary markets, resulting in the need for more complex, convergent, and new operating systems. Moreover, existing processes and methods for evaluating applications and operations associated with annuities and mortgages include rigid rules that may be time consuming, laborious to review, and often require manual labor. To achieve a more secure system while maximizing the profits of customers and product and related service providers, combining these two different complex systems, support for advanced technology is needed. Accordingly, there exists a need for improved systems and methods to address these and other shortcomings, including for tendering financial products to prospective customers and evaluating applications for such products from prospective customers.

### SUMMARY

In an aspect of the disclosure, a method implemented on an on-location premises evaluation device is provided. The method may include sending, to a display of the device, a prompt for a user to begin an on-location premises evaluation. The method may include upon receiving, from the user interface of the device, confirmation from the user to being the evaluation, initiating the on-location premises evaluation. The method may include prompting the user to begin a walk-through of a structure associated with the premises. The method may include initiating, at the device, a data recording process to capture at least one of a dimension measurement and imagery information of the premises. The method may include capturing at least one of a 3D model, a dimension measurement of the structure including at least one inside dimension and one outside dimension, or at least one room quantity. The method may include capturing the recording data including at least one user attribute including at least one of a demographic and user preference attribute. The method may include sending, to a remote server, the recorded data. The method may include receiving, from the remote server, a response including at least one of a numerical assessed valuation.

In another aspect of the disclosure, a method implemented on a server in communication with a remote on-location premises evaluation device is provided. The method may include receiving, from the remote on-location premises evaluation device, a request for a numerical assessed valuation associated with real property of the premises, wherein the request includes at least one of: 1) at least one of a dimension measurement and imagery information of the premises, 2) a dimension measurement of the structure including at least one inside dimension and one outside dimension; at least one room quantity, 3) at least one user attribute including at least one of a demographic and user preference attribute. The method may include determining, by querying a valuation data model, the numerical assessed valuation based on the request, wherein the data model includes a sets of attributes associated with the request. The method may include sending, to the remote on-location premises evaluation device, the determined numerical assessed valuation.

### BRIEF DESCRIPTION OF THE DRAWINGS

The present disclosure is illustrated by way of example, and not by way of limitation, and may be more fully understood with reference to the following detailed description when considered in connection with the figures below.

FIG. 1 illustrates an exemplary financial services processing application including mobile financial processing units, a business-to-business (B2B) financial services process unit, a mortgage processor server system, and a data storage unit, according to an embodiment of the disclosure.

FIG. 2 is an exemplary block diagram of the mobile financial services processing unit device of FIG. 1, according to an embodiment of the disclosure.

FIG. 3 is an exemplary AI-enabled system that may be the mobile financial processing unit, or the B2B financial processing server unit, or the mortgage processer server system, or a separate system coupled to any one of the units described herein, according to an embodiment of the disclosure.

FIG. 4 is a diagram illustrating the process flow for training an AI model using a dataset with a deep neural network including a set of parameters, according to an embodiment of the disclosure.

FIG. 5 is an exemplary diagram illustrating a display screen of a mobile device showing a dashboard view of available functions, according to an embodiment of the disclosure.

FIG. 6 illustrates an example evaluation process with a user on a mobile device, with the user being on-location or on the premises of a real estate property, according to an embodiment of the disclosure.

FIG. 7 illustrates an example mobile device capture screen, e.g., based on the evaluation process in FIG. 6, according to an embodiment of the disclosure.

FIG. 8 is an exemplary diagram illustrating a display screen of a mobile device showing a policy view including policy information, according to an embodiment of the disclosure.

FIG. 9 is an exemplary diagram illustrating a display screen of a mobile device showing prompts and responses, according to an embodiment of the disclosure.

FIG. 10 is an exemplary diagram illustrating a display screen of a mobile device showing question and answer panels, according to an embodiment of the disclosure.

FIG. 11 is an exemplary diagram illustrating a display screen of a mobile device showing example mortgage information, according to an embodiment of the disclosure.

FIG. 12 is an exemplary diagram illustrating a display screen of a mobile device showing example comparison of mortgage loans, according to an embodiment of the disclosure.

FIG. 13 is an exemplary flow diagram illustrating a method of monitoring a user's financial condition, according to an embodiment of the disclosure.

FIG. 14 is an exemplary flow diagram illustrating a method of determining available financial products, according to an embodiment of the disclosure.

FIG. 15 is an exemplary flow diagram illustrating a method of the provision of financial services, according to an embodiment of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Methods and systems are provided for improved mortgage and annuities services through devices including various mobile, server, and other types of devices.

In a sample mortgage process, the process may being with receiving an application from a prospective buyer. A custodian may receive and review the application for completion. A mortgage servicer may mark or tag the application with the suitable marks.

The disclosure includes discussion of integration of advanced financial products, a mortgage loan, and a fixed index annuity to mitigate risks of default on mortgage loans and at the same time, or in the alternative, solution to chronic risks associated with failure of retirement income preparation due to the psychological pressure of long-term savings. A mortgage loan is typically a loan, between the purchaser and lender, used to purchase or maintain a home, land, or other types of real estate. An annuity is typically a form of insurance or investment entitling the investor to a series of payments (usually monthly or annual payments).

In some cases, problems may start with preparing capital as a down payment to build real estate assets, which may usually be considered a safe asset class and a priority for wealth accumulation. Although a prospective purchaser may seek to use various financial products to help accumulate and save money as a downpayment, many prospective purchasers, nevertheless, may fail to either use these products or fail to otherwise to gather funds for a down payment. In markets like the current US real estate market, the gap between the average incomes and real estate values is large, so that saving the down payment may be prohibitively difficult for many savers. It may be desirable for safe and profitable products to be held for a long period of time. In case of short-term withdrawals from these products, there are various fees and penalties within certain limits which may be a reason many homebuyers use some types of bank accounts that don't earn interest but have liquidity. The substantial capital is invested as a down payment to obtain a mortgage that has a leveraged effect to build real estate assets. Some estimate that the total amount of mortgage loans in 2023 may be around 11.92 trillion dollars suggesting that not all mortgagees are enjoying the benefit of some advanced financial products that may generate retire incomes at the same time as collateral for mortgages. In some cases, a borrower may be responsible for paying off the mortgage over an average of thirty years, which for some people may last until retirement.

In some embodiments, through an annuity function, saving for the down payment may be grown by way of compound interest according to indexes of the, e.g., equity market with beneficial features such as downside protection, while enjoying tax deferment.

In some embodiments, services and products provide for a mortgage that may be acquired by twenty percent of the value of the property a prospective buyer wishes to purchase. In other embodiments, the property may be acquired using a down payment of zero to one hundred percent; in case of one hundred percent, the buyer may receive other benefits or offsets. The remainder of the property value (up to one hundred percent) may be financed, e.g., by an insurance company. Because the cash value may not be withdrawn for the downpayment, there may not be withdrawal fees or penalties. It can remain as cash value to generate interest to cover the difference of twenty percent more financing. From some perspectives, the payment made by the borrower or mortgagee may be seen as equivalent to an eighty percent loan instead of a hundred percent loan.

In some embodiments, the insurance company may collateralize the cash value and calculate the loan-to-value (a measure comparing the amount of the mortgage with an appraised value of the property) on this basis. In some cases, the monies such as the cash value may be invested and diversified in portfolio-type investments which may include real estate, stocks, bonds, commodities, etc. For instance, in the event of a short-term emergency (e.g., changed market conditions, changed employment situation of the homeowner, etc.) the cash value may be accessed for reducing or eliminating the difficulties associated with the emergency; for example, mortgage repayments may be made by accessing the cash value. The liquidity of the financial services provider of these services may ensure solvency, and thereby resolve problems of limited liquidity in real estate assets. The diversification of the down payment may protect against defaults of the repayments due to a downturn in the housing market. In case of underwater loans, the value of houses may be upside down, but these loans may be offset by the cash value based on stocks and bond equity. The house value may decline but the cash value associated with the down payment with the downside protection in some cases may not decrease but may increase in value. Accordingly, these innovations may provide significant, and in some cases revolutionary, benefits in the area of financial services for real estate assets, and in particular for mortgage services. In some cases, it may be beneficial to seek out these advantages of solvency, liquidity, and asset value early in the process for either or both of the prospective client or financial service provider.

Retirement income may be an asset that may require long-term investment as much as real estate investment. In some cases, the time to create retirement income may be missed. Therefore, many retirees expect reverse mortgages, but they have to endure various disadvantages.

In this disclosure, various systems and methods may be used to facilitate the methods described in the preceding paragraphs. In some embodiments, methods and apparatuses may be provided for facilitating the entire process from beginning to end and throughout. In some methods various artificial intelligence (AI) methods and apparatuses may be applied to facilitate the methods described. In some examples, any combination of data gathered or generated may be used in the methods. As an example, neural networks (NN), including artificial neural networks (ANN) may be applied to the methods and systems.

A human brain may work in a different manner from that of a computer. While computers may use digital logic and control (e.g., 0s and 1s), the human brain is a slower collection of nodes called neurons. These neurons may be connected by synapses which pass electronic or chemical signals in the brain. These connections may be capable of changing each time information is sent or received representing adaptation and learning. A neutral network may be an artificial computer-generated system that attempts to replicate the neural system of the human brain. Nodes may be used to represent neurons, and they may be connected with different weights that represent the synapses of the neurons. These networks may be trained to process different information and learn from it. Naturally theses systems may be used to mimic certain functions that the human brain may be capable of performing, such as pattern recognition and decision making. While the brain may be capable of performing these functions, properties inherent to computers, AI systems, and networks allow computers to transcend the capabilities of human brains in the scale, complexity, etc. of the systems.

Some systems may use any suitable simple neural network logic gates and functional units including the linear threshold gates. In some examples, the neural networks may be described in various ways and forms, some examples may include processing units, weights, a computation method, and a training method.

In some embodiments, the neural network may include feedforward networks.

Those skilled in the art will readily recognize that the disclosure is not so limited to the above types and mechanisms of neural networks. In other examples, ANNs such as regulatory feedback networks, radial basis function networks, recurrent neural networks, modular networks, etc. may be used based on user design and preference.

It may be appreciated that existing methods for financial services are time consuming and require significant manual labor. For example, the process for intake of customer requests and data often requires person-to-person exchanges. As well, some of the process may be error prone due to the manual methods used. The disclosed methods, however, improve on the existing methods and provide for the many benefits.

Artificial intelligence may refer to the field of studying artificial intelligence or methods for making artificial intelligence, and machine learning refers to the field of defining various issues dealt with in the field of artificial intelligence and studying methods for solving the various issues. Machine learning is defined as a computer algorithm that enhances the performance of certain tasks through experience with tasks and the use of data, and in some cases a large amount of data.

A neural network or artificial neutral network is a model used in machine learning and may mean a model of problem-solving ability which is composed of artificial neurons (nodes) that form a network by synaptic connections. The artificial neural network may be defined by a connection pattern between neurons in different layers, a learning process for updating model parameters, and an activation function for generating an output value.

The ANN may include an input layer, an output layer, and optionally one or more hidden layers, Each layer includes one or more neurons, and the ANN may include a synapse that links neurons to neurons. In the ANN, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the ANN may be to determine the model parameters that minimize a loss function. The loss function may be used as an index to determine optimal model parameters in the learning process of the ANN.

Machine learning may be classified into supervise learning, unsupervised learning, and reinforcement learning according to a learning method.

The supervised learning method may refer to a method of learning an ANN in a state in which a label for learning data is given, and the label may mean the correct answer (or result value) that the ANN must infer when the learning data is input to the ANN. The unsupervised learning may refer to a method of learning an ANN in a state in which a label for learning data is not given. The reinforcement learning may refer to a learning method in which an agent defined in a certain environment learns to select a behavior or a behavior sequence that maximizes cumulative compensation or some type of reward in each state.

Machine learning, which may be implemented as a deep neural network (DNN) including a plurality of hidden layers among ANN, is also referred to as deep learning, and the deep learning is a part of machine learning.

An AI device or apparatus used herein may refer to a machine that automatically processes or operates a given task by its own ability. In particular, an AI device having a function of recognizing an environment and performing a self-determination operation may be referred to as an intelligent device. In some cases, an intelligent device may be referred to as an android or other artificial being. In the disclosure, AI device, intelligence machine, android, artificial machine, may be used interchangeably.

It will be appreciated by those skilled in the art that any of the artificial intelligence features may be used in combination with the methods described herein; in some embodiments, the methods and apparatuses may be practiced without the use of any or all of the artificial intelligence features.

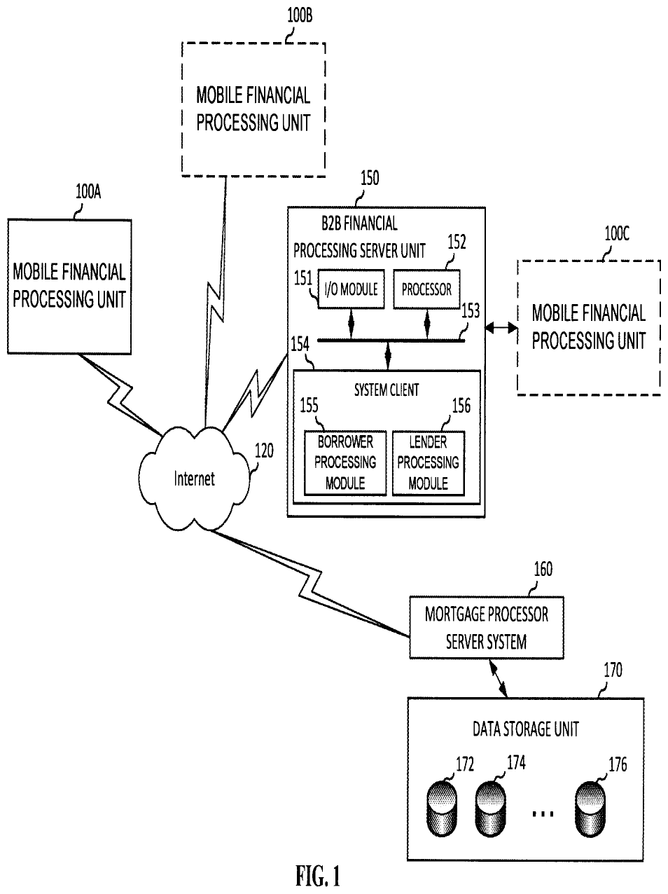

FIG. 1 illustrates an example financial services processing system including mobile financial processing units 100A, 100B, 100C, a business-to-business (B2B) financial services process unit 150 (which may also be interchangeably referred to as a B2B processing unit 150 or module 150), a mortgage processor server system 160, and a data storage unit 170, according to an embodiment of the disclosure. While the unit 150 may be called a business-to-business unit 150, it may be appreciated that the unit 150 may be used in any one of various scenarios including between financial companies/organizations, between the companies and end users, or for internal services within the company. In some examples, the unit 150 may be used by end users. Some elements such as mobile financial processing units 100B, 100C may be optional. Any type of end user may be a user of the mobile financial process unit 100A. For example, a person seeking an annuity and/or mortgage product may be the user of mobile financial processing unit 100A. A financial services provider may be the user for B2B financial processing server unit 150. In some embodiments, B2B processing unit 150 may be in communication and/or coupled to another B2B processing unit 150, for example, for inter-company or intra-communication connections. The various units may be coupled via the internet 120, or any other suitable communication link such as satellite links, terrestrial links, wireless links, and the like. The B2B server unit 150 may be coupled to a mortgage processor server system 160. The mortgage processor server system 160 may be coupled to a data storage unit 170 containing one or more databases 172, 174, 176. In some embodiments, one or more of the databases 172, 174, 176 may contain customer information such as users of the mobile financial process unit 100A.

B2B server unit 150 may include processor 152, I/O module 151, display screen, camera, one or more speakers, microphone, data bus 153 used for communication between the components, and a system client 154 including a borrower processing module 155 and lender processing module 156, each of which may be implemented as either a software application and/or hardware component and may be executable by processor 152 to facilitate provision of financial services by devices such as device 100A in communication with B2B financial processing server unit 150 in a financial services system. Processor 152 may also operate I/O module 151, display screen, camera, speaker, microphone, in support of the provision of financial services as per instructions provided by system client 154. For example, I/O module 151 may send and receive data to and from the end users of the financial services system; received data may be displayed on display screen; camera may provide video data to be sent to user devices such as device 100A; speaker(s) may play received audio; microphone may provide audio input to be sent to devices such as device 100A. In some embodiments, I/O module 151 may include encryption algorithms to provide secure end-to-end communications and financial services processing with mobile devices or servers units. In other embodiments, a separate module (not shown) coupled to the processor 152 may be configured to provide the encryption algorithms to provide secure end-to-end communications. In yet other embodiments, separate modules or recording devices may be coupled to unit 150 or processor 152 to provide additional capabilities associated with providing services or receiving data from end users.

In accordance with embodiments described herein, borrower processing module 155 may be implementable either as a software application and/or hardware component that may be implemented as either an integrated component of system client 154 or as an independent module in communication with system client 154. Borrower processing module 155 may be configured to perform functions associated with intake and offer of financial services including servicing initiate services for mortgagees, such as on device 100A.

In accordance with embodiments described herein, lender processing module 156 may be implementable either as a software application and/or hardware component that may be implemented as either an integrated component of system client 154 or as an independent module in communication with system client 154. Lender processing module 156 may be configured to perform functions associated with payment and other offers of financial services including payment processing for end users, such as on device 100A.

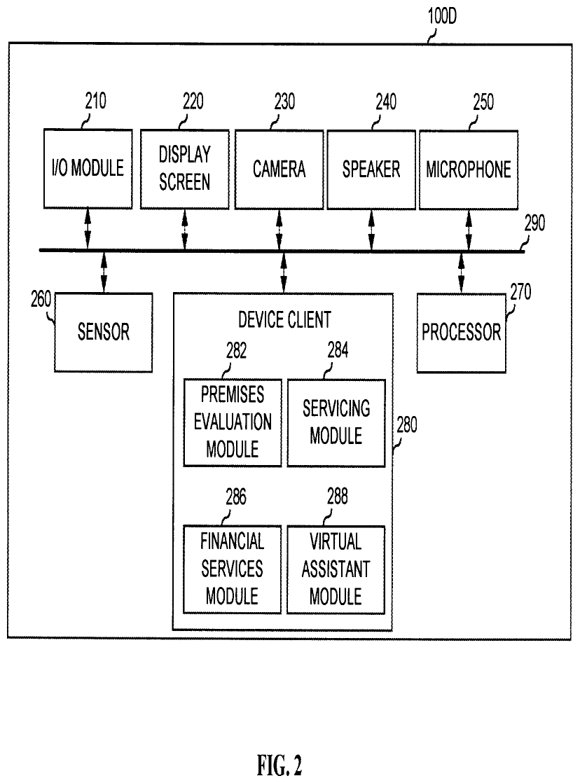

FIG. 2 is an exemplary block diagram of the mobile device or mobile financial processing unit 100A of FIG. 1. Financial processing unit 100D, or simply referred to as device 100D, may include processor 270, I/O module 210, display screen 220, camera 230, one or more speakers 240, microphone 250, sensor device 260, data bus 290 used for communication between the components, and financial processing device client 280, which may be implemented as either a software application and/or hardware component and may be executable by processor 270 to facilitate financial services by device 100D in a financial services interaction or transaction. Processor 270 may also operate I/O module 210, display screen 220, camera 230, speaker 240, microphone 250, and sensor 260 in support of providing financial services as per instructions provided by device client 280. For example, I/O module 210 may send and receive data to and from other devices, e.g., to facilitate financial services between or among the various users and devices such as such as B2B server unit 152 or mortgage processor server system 160 acting as a remote server or to other mobile devices (e.g., a remote device) such as device 100A of FIG. 1. Received data may be displayed on display screen 220; camera 230 may provide video data to be sent to other devices 100D; speaker(s) 240 may play the received audio data; microphone 250 may provide audio input to be sent to other devices; and sensor(s) 260 may read data from or around the user (e.g., a home buyer) of the device 100D to send to one or more of the servers or other devices. In some embodiments, I/O module 210 may include encryption algorithms to provide secure end-to-end communications with other mobile devices or servers units such as server unit 150 of FIG. 1. In some embodiments, financial services may be facilitated using the secure end-to-end communications. In other embodiments, a separate module (not shown) coupled to the processor 270 may be configured to provide the encryption algorithms to provide secure end-to-end communications.

In some embodiments, the financial services processing units may be in communication with each other in a peer-to-peer configuration. For example, two or more end users such as home buyers may use the devices to communicate between themselves or provide peer-to-peer processing to combined processing power. In other embodiments, any combination of server devices and end user devices may be in communication.

In accordance with embodiments described herein, device client 280 may include a premises evaluation module 282 (e.g., analysis of a physical location, land, building, house, complex, business office location, and the like), a servicing module 284, a financial services module 286, and a virtual assistant module 288, which in some embodiments may be an AI-enable module. In some embodiments, the premises evaluation module 282 may be implementable either as a software application and/or hardware component that may be implemented as either an integrated component of device client 280 or as an independent module in communication with device client 280. As will be described below, premises evaluation module 282 may be configured to perform premises evaluation routines on the device 100D. In some examples, the device 100D may be used as part of a real estate evaluation process, such as by a prospective homeowner evaluating the suitability of a new property, or may be used as part of the process for securing a loan or other financial instrument regarding the property (e.g., for purchase of the property). It may be appreciated that the device 100D may be used by any category of users including prospective home buyers, those seeking financial assistance or loans, or businesses evaluating a property. In some embodiments, the premises evaluation module 282 may be included on a server unit such as B2B server unit 150 of FIG. 1.

Device client 280 may include a financial service module 286. This module 286 may provide some or all of the traditional financial services, alone, or in conjunction with the various improvements disclosed herein. In some embodiments, the financial services module 286 may be implementable either as a software application and/or hardware component that may be implemented as either an integrated component of device client 280 or as an independent module in communication with device client 280. In some embodiments, the financial services module 286 may provide such functions as payment processing, providing payment reminders, requesting updated biographical or other information of the user to provide to the server unit. In some embodiments, the financial services module 286 may provide services associated with one or both of annuities or mortgage tasks.

Device client 280 may include a servicing module 284. The module 288 may be implementable either as a software application and/or hardware component that may be implemented as either an integrated component of client 280 or as an independent module in communication with client 280. In some embodiments the module 288 may be used as a module 288 for a server, such as server unit 152 of FIG. 1. In some embodiments, the module 288 may be a distributed or centralized, or peer-to-peer module (e.g., using processing power of mobile financial processing units in communication with each other), or any combination thereof. The module 288 may perform any one of the data collection, data generation, training, and model refinement, or application of the model processes.

Client may include a virtual assistant module 288, which in some embodiments may be an AI-enabled module. Virtual assistant module 288 may be implementable either as a software application and/or hardware component that may be implemented as either an integrated component of client 280 or as an independent module in communication with the client 280. As will be described below, virtual assistant module 288 may be configured to perform virtual assistant functions such as interacting with a user (e.g., a prospective/existing financial services customer or a user on the institutional or financial services provider company) of the device 100D. Such interactions, for example, may include answering user queries or questions, and the interactions may include gathering information from the user to send to the module. When the device 100D is used by the customer side (compared to the business side), the virtual assistant module 288 may provide answers regarding financial information or other general provider-side information. Virtual assistant module 284 may work in conjunction with any one of the other modules 282, 284, 286 to determine interactions and provide relevant information and responses to queries.

Virtual assistant module 288 may include software and/or hardware for creating the AI model used to interact with the user. In other embodiments, the AI model may be previously created (e.g., at a dedicated or distributed processing node(s)) with the resulting model copied to the module 288.

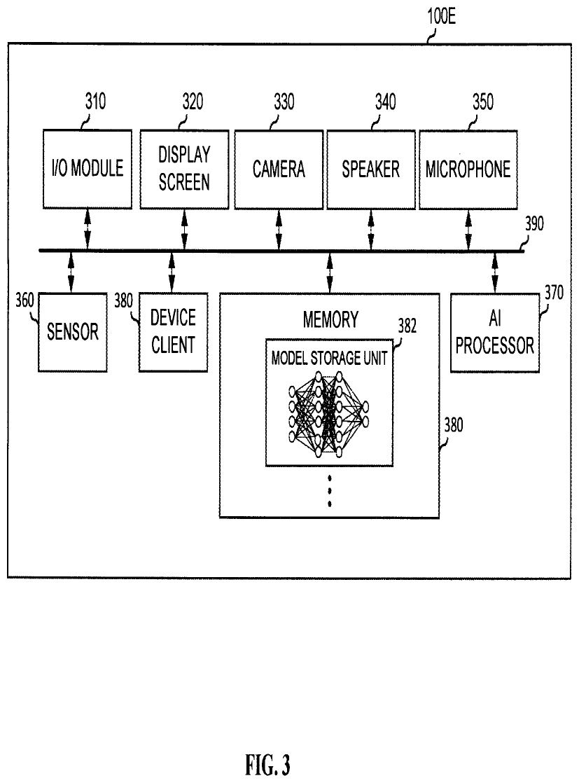

FIG. 3 is an exemplary AI-enabled system that may be the mobile financial processing unit or device (e.g., 100A of FIG. 1, or 100D of FIG. 2), or the B2B financial processing server unit (e.g., unit 150 of FIG. 1), or the mortgage processer server system (e.g., system 160 of FIG. 1), or a separate system coupled to any one of the units described herein, according to an embodiment of the disclosure. The system may be referred to as financial processing unit 100E or device 100E. In case the device 100E is device 100D of FIG. 2, the similar components may function similarly, and AI components (e.g., AI process 370) may be used in addition to or in lieu of the similar component (e.g., processor 270). The system may be in communication with and coupled to a cloud network or the internet.

The AI-enabled system may be a device 100E that processes an artificial neural network by using a machine learning algorithm or uses a learned artificial neural network. The AI-enabled system may include or be coupled to a set of servers to perform distributed processing, or in some cases, centralized processing, or cloud-based processing, e.g., over a network. The system may perform any combination of processes associated with the AI functions. As disclosed above, the system may include some similar features and units performing similar functions as those in FIG. 2. Some details for similar components may be omitted for brevity.

Device 100E may include processor 370, I/O module 310, display screen 320, camera 330, one or more speakers 340, microphone 350, sensor device 360, data bus 390 used for communication between the components, and device client 380, which may be implemented as either a software application and/or hardware component and may be executable by AI processor 370 to facilitate financial services by device 100E in a financial services interaction or transaction. AI processor 370 may also operate I/O module 310, display screen 320, camera 330, speaker 340, microphone 350, and sensor 360 in support of financial services as per instructions provided by client 380. Device client 380 may be device client 280 of FIG. 2, or may include any or all of the modules 282, 284, 286, 288 or FIG. 2. I/O module 310 may send and receive data to and from other devices, e.g., to facilitate financial services between or among the various users; received data may be displayed on display screen 320; camera 330 may provide data to be sent to other devices; speaker(s) 340 may play the received audio data; microphone 350 may provide audio input to be sent to other devices; and sensor(s) 360 may read data from or around the user (e.g., a home buyer) of the device 100D to send to one or more of the server devices (e.g., server unit 150 of FIG. 1). In some embodiments, I/O module 310 may include encryption algorithms to provide secure end-to-end communications with other mobile devices or servers units (e.g., server unit 150 of FIG. 1). In some embodiments, financial services may be facilitated using the secure end-to-end communications. In other embodiments, a separate module (not shown) coupled to the AI processor 370 may be configuration to provide the encryption algorithms to provide secure end-to-end communications. While AI processor 370 is indicated as an AI component, the component is provided as a non-limiting example. Non-AI processors and components may be used in addition to or in lieu of the AI process 370.

The memory 380 may include a model storage unit 382. The model storage unit 382 may store a learning or learned model (or an artificial neural network) through the AI processor 350. The AI processor 370 may learn the artificial neural network by using the learning data. The learning model may be used in a state of being mounted on one of the servers of the artificial neural network, or may be used in a state of being mounted on an external device such as device 100A of FIG. 1.

The learning model may be implemented in hardware, software, or a combination of hardware and software. The processor 370 may infer the result value for new input data by using the learning model and may generate a response or a control command based on the inferred result value.

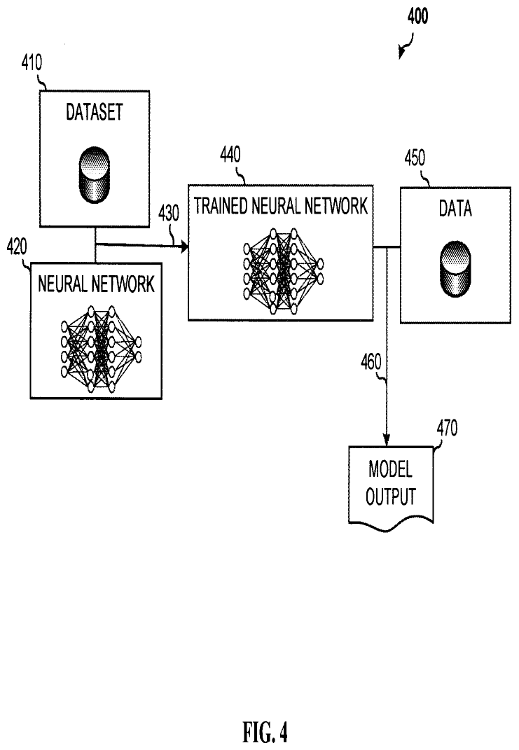

FIG. 4 is a diagram 400 illustrating the process flow for training an AI model using a dataset 410 with a deep neural network 420 including a set of parameters, according to an embodiment of the disclosure. For example, the training may be used on any of the devices such as device 100A of FIG. 1, device 100D of FIG. 2, device 100E of FIG. 3, etc. or server unit 150, system 160 of FIG. 1. For example, the neural networks 420, 440 may be memory storage unit 382 of memory 380 of FIG. 3. Once a given neural network 420 has been structured for a task the neural network 420 is trained using a training dataset 410. It will be appreciated by those skilled in the art that the dataset 410 may be a dataset gathered from real information, or in other examples, may be a generated dataset. Various training frameworks may be developed for the training process 430. The training framework may hook into an untrained neural network 420 and enable the untrained neural network 420 to be trained to generate a trained neural network 440. At the start of the process, the initial weights of the untrained neural network 420 may be chosen randomly or by pretraining using a deep belief network.

The training cycle may then be performed in either a supervised or unsupervised training process 430. Supervised learning is a learning method in which training may be performed as a mediated operation, such as when the training dataset 410 includes input paired with the desired output for the input, or where the training dataset includes input having known output and the output of the neural network is manually graded. The network may process the inputs and compare the resulting output against a set of expected or desired results. Errors may then be propagated back through the process. The training framework may adjust the weights that control the untrained neural network 420. The training framework may provide tools to monitor the progress of the training process is converging toward a model suitable to generate correct answers based on known input data. The training process 430 may occur repeatedly as the weights of the network 420 are adjusted to refine the output generated by the neural network. The training process may continue until the neural network reaches a desired level of accuracy for the trained neural network 440. The trained neural network 440 may be deployed to implement any number of machine learning operations. For example, with the trained neural network, the network may be applied to new data 450 to generate 460 results or output 470 of the model.

Unsupervised learning is a learning method in which the network may attempt to train itself using unlabeled data. In the example of unsupervised learning, the dataset 410 may include input data without any associated output data. The untrained neural network may learn groupings within the unlabeled input and may determine how individual inputs are related to the overall dataset. Unsupervised training may be used to generate a self-organizing map, which may be a type of trained neural network 440 capable of performing operations useful in reducing the dimensionality of data. Unsupervised training may be used to perform anomaly detection, which may allow identification of data points in an input dataset that may represent abnormal readings indicative of certain financial or real estate anomalies including, for example, fraud or defect detection.

In some embodiments, the neural networks 420, 440 may be a large language model (LLM) providing for natural language processing (NLP) tasks. Large language models may use transformer models and may be trained using “big data” or very large datasets that are too large to process using either manual processing or traditional data processing methods. This may enable the LLMs to recognize, translate, predict, or generate text or other content. In the example of FIG. 4, the neural network may be an LLM 420. In some examples, the dataset for an LLM may be labeled or unlabeled data. After the training process 430, the trained neural network (LLM) 440 may be fine-tuned with another (e.g., smaller) dataset that may be labeled (or in some cases unlabeled) for fine tuning. In other examples, the training process 430 may be iterative to produce improved results.

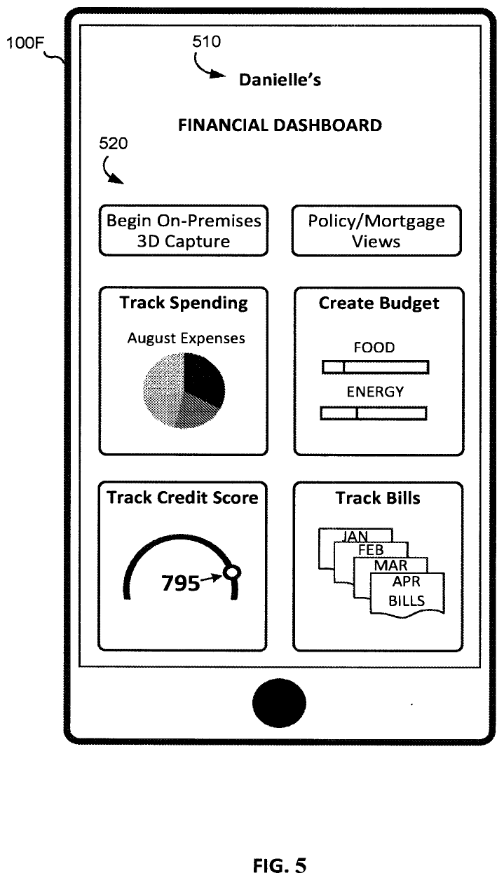

FIG. 5 is an exemplary diagram illustrating a display screen of a mobile device 100F showing a dashboard view of available functions, according to an embodiment of the disclosure. For example, the mobile device 100F may be a mobile financial processing unit 100A, or the B2B financial processing unit 150. In some examples, the mobile device 100F may be a mobile tablet device, smart phone, wearable device, etc. The example dashboard screen on the mobile device 100F may include a personalized header or title 510 such as “Danielle's Financial Dashboard.” Various features 520 such as 3D capture, policy or mortgage views, tracking spending, creating a budget, tracking credit score, or tracking bills may be shown on the screen of the mobile device 100F. Not all available features may be visible or available to all users. As may be suitable for mobile device applications, the screen and features may be customized to the user's preferences.

It will be appreciated by one skilled in the art that any of various dashboard or other types of views may be available and presented to the user.

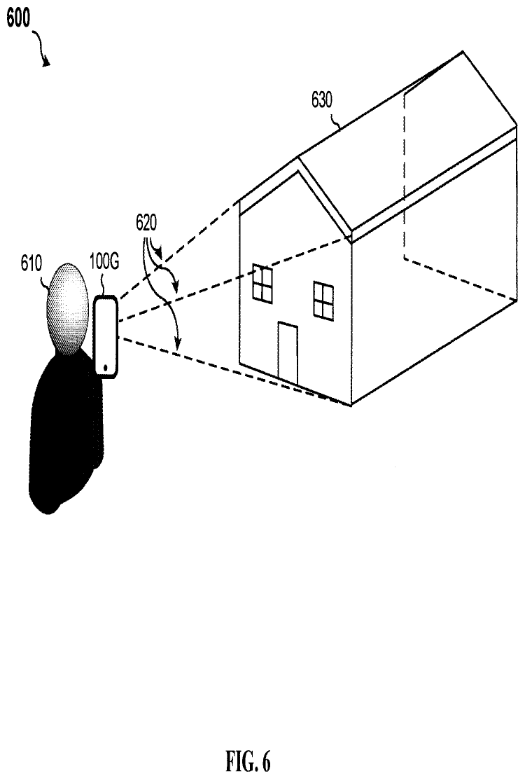

FIG. 6 illustrates an example evaluation process 600 with a user 610 on a mobile device 100G, with the user 610 being on-location or on the premises of a real estate property 630, according to an embodiment of the disclosure. The user 610 may be a prospective financial services client seeking, for example, financing for purchase of real estate property 630.

In the example of FIG. 6, the user 610 may be prompted by the mobile device 100G to begin the evaluation process of the property 630. In the example shown, the user 610 may be on-premises or on-site and may use the sensors or inputs such a camera, microphone, etc. available on the mobile device 100G to capture 620 a three-dimensional (3D) model of the property 630. The user 610 may also capture any attributes of the premises 630, including outside and/or inside attributes such as dimensions, volume, lengths of various walls, color, number of rooms, yard area, backyard area, etc. In some embodiments, the device 100G may guide the user 610 through the process. In other embodiments, the user 610 may proceed according to the user's 610 own process preferences. Once information of the property 630 is captured 620, the mobile device 610 may provide feedback information, either using AI-enabled methods, or without the AI-enabled methods providing statistical information for the property 630. Those skilled in the art will appreciate that representation of the property 630 need not include on-site and/or capture of physical attributes of the property 630. In other examples, information from public or private sources, such as property databases, government records, satellite imagery, or road-level imagery may be used in addition to or in lieu of the on-site evaluation process. In some examples, any of the various levels of information may be supplied, from a single piece of information such as a physical address or photo of the property 630 to a large set of available information including the 3D model and database information. Based on the information, various financial products such as a mortgage with or without an annuity rider, may be determined that are suitable for the user 610.

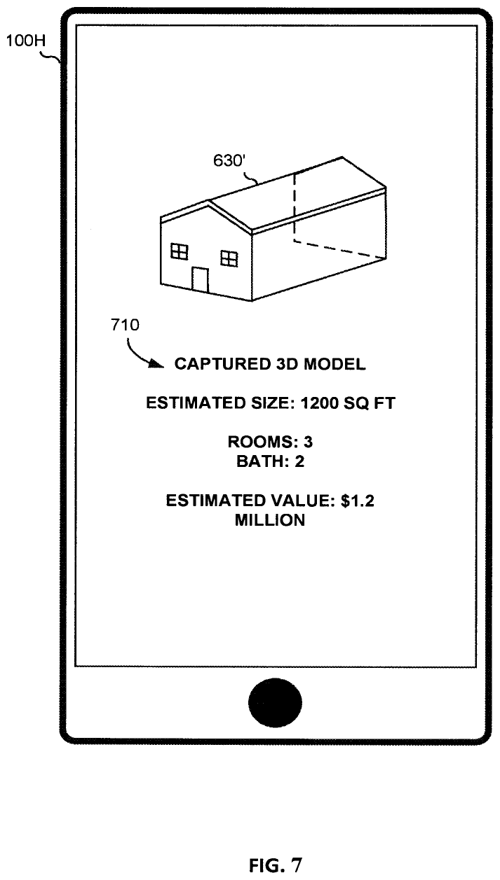

FIG. 7 illustrates an example device 100H capture screen, e.g., based on the evaluation process in FIG. 6, according to an embodiment of the disclosure. The device 100H may present a 3D, wire, etc. model of the property 630′ or the premises that the user captured using the device 100H. The device 100H may also, in addition or in alternative to the captured model 630′, present various information 710 associated with the property 630′. For example, the information 710 may include labels such as “Captured 3D Model” indicating successful imagery capture of the property 630′, estimated size, number of rooms, bathrooms, and estimated value of the property. The estimated value label may be generated through the AI-enabled methods disclosed herein. In an example, while the user is capturing the various attributes of the property 630′, the information may be sent to a remote server (such as remote server 160 of FIG. 1) with a prepared neural network to process information sent to the server. Based on the information, an estimated valuation may be generated. In some examples, the attributes and information (e.g., income, assets, credit score, age, residential address, etc.) for the user may also be sent to the remote server for processing to generate a response including suitable financial products for the user. The remote server may generate loan information based on the received information. Information associated with the suitable financial products may be presented to the user (not shown).

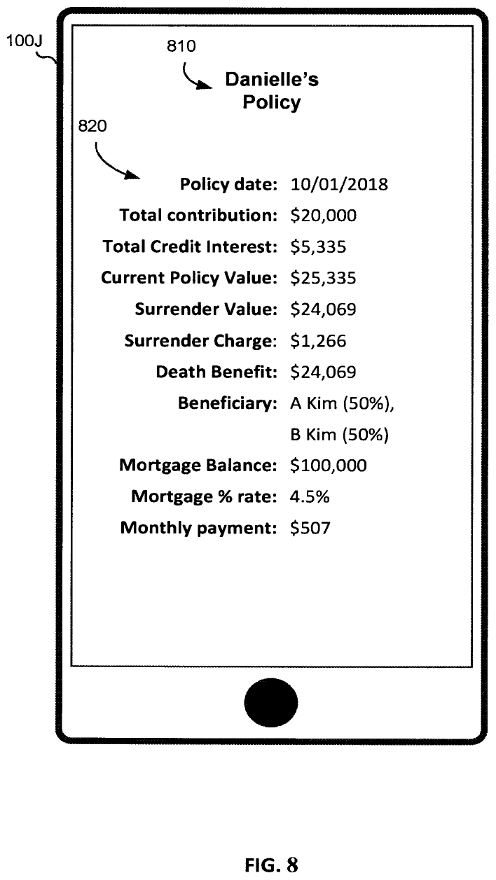

FIG. 8 is an exemplary diagram illustrating a display screen of a mobile device 100J showing a policy view including policy information, according to an embodiment of the disclosure. The view may include a header 810 and policy information 820 for the user, including such information as total contribution, interest paid, policy value, surrender value, etc.

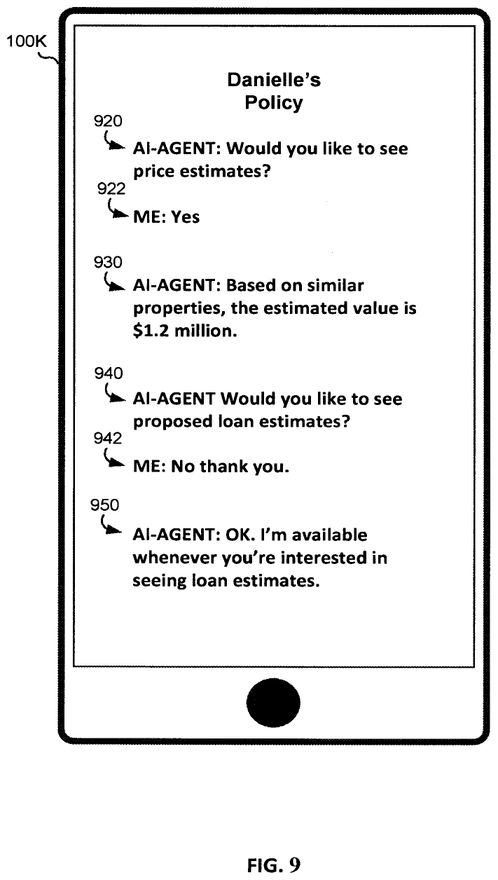

FIG. 9 illustrates an example device 100K query screen including prompts and responses from a user, according to an embodiment of the disclosure. The AI prompts may be generated in response to the evaluation process shown in FIG. 6. In other examples, the query screen may be presented in response to other triggers, or spontaneously without any triggers. In some examples, the query screen may relate to financial products available based on information associated with the user and/or a property visited by the user sent to a remote server. In some examples the query screen may provide a set of prompts for the user of the device 100K. In the example shown in FIG. 9, the AI agent or “AI-Agent” (e.g., a system client such as client 280 of FIG. 2 or client 380 of FIG. 3, running on the device). The AI agent may prompt, at label 920, the user if the user “would like to see price estimates” associated with a property (e.g., a property that the user has visited during an on-premises evaluation as shown in FIG. 6). Based on information associated with the property, the AI agent may provide information at label 930 on the estimated value if the user responds at label 922 in the affirmative. The AI agent may prompt at label 940 the user if the user “would like to see proposed loan estimates” associated with a property. If the user responds in the affirmative, the AI agent may present various proposed loan estimates. If the user responds at label 942 in the negative (as shown in FIG. 9), the AI agent may avoid showing any such proposed loan estimate. The AI agent may display at label 950 an indication that the AI agent is available as the user's request. The available loan information may be stored on the device 100K and available for viewing at a later time upon request of the user.

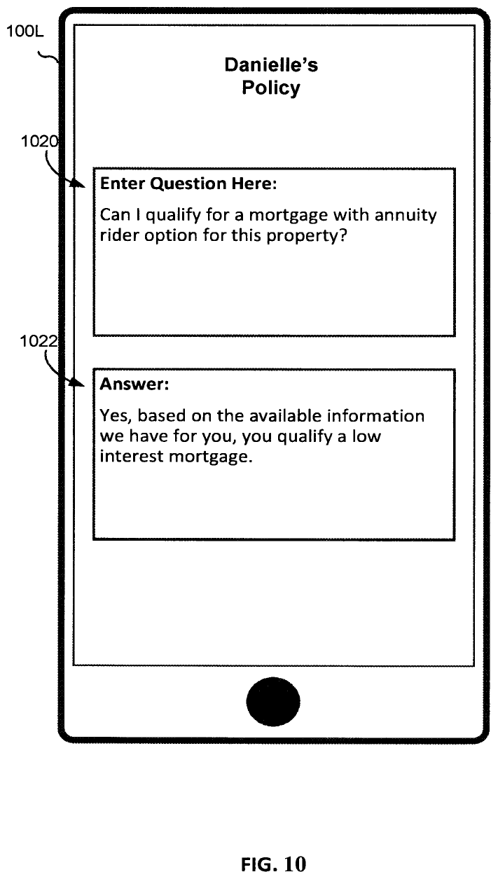

FIG. 10 is an exemplary diagram illustrating a display screen of a mobile device 100L showing question panel 1020 and answer panel 1022, according to an embodiment of the disclosure. In some embodiments, this screen may have similar functionality as the AI agent screen in FIG. 9, with the example of FIG. 10 providing a client-driven chat, conversation, or exchange; in other words, the example of FIG. 9 beings with prompts from the AI agent, whereas the example of FIG. 10 may allow the user to initiate and control the chat session. In some examples, the question panel 1020 and answer panel 1022 may use the AI agent module; in other examples, the feature may use real human agents to provide responses in the answer panel 1022.

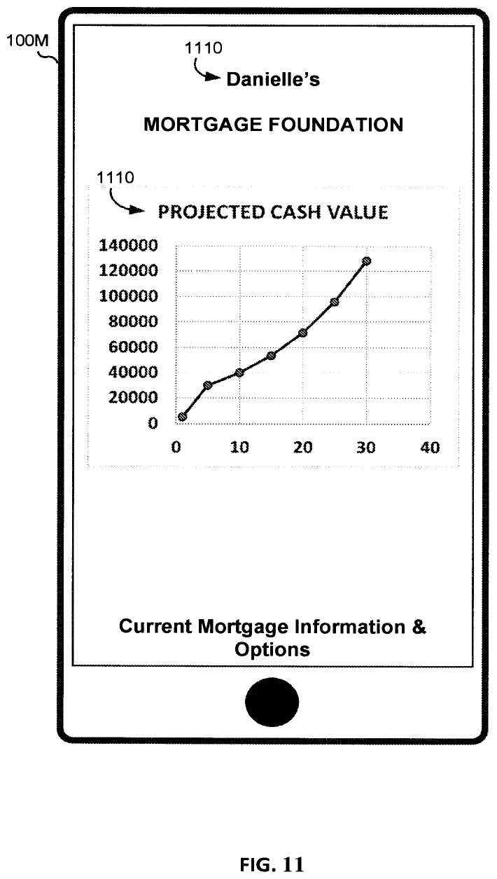

FIG. 11 is an exemplary diagram illustrating a display screen of a mobile device 100M showing example mortgage information 1110, according to an embodiment of the disclosure. This screen may provide various information for the user's mortgage. In the example display screen, a chart information 1110 of example growth in value of a given initial investment of cash value growing based on certain periodic (e.g., monthly, yearly, etc.) contributions with compound interest at a certain rate (e.g., six percent) that grows to a certain amount over time. In the example of FIG. 11, an example initial value of five thousand dollars with three additional contributions of five thousand dollars each may generate an investment worth over $120,000 over a thirty-year period.

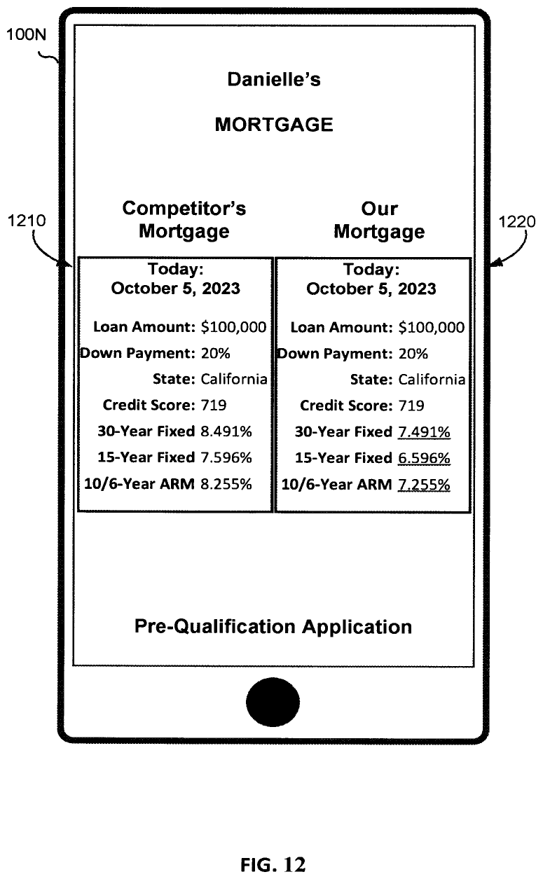

FIG. 12 is an exemplary diagram illustrating a display screen of a mobile device 100N showing example comparison of mortgage loans 1210, 1220, according to an embodiment of the disclosure. Prospective clients may desire to see available mortgage loans 1210, 1220, e.g., based on an evaluation of a real estate property as shown in FIG. 6. The mobile device 100N may provide information for an offer of a mortgage loan 1220 along with that of a competitor's mortgage loan 1210. In the example shown, the mortgage loan 1220 provides advantageous mortgage rates compared to the competitor's option. The competitive rates may be available due to any combination of improvements such as the evaluation process of the prospective client (e.g., the user of the mobile device 100N), through improvements and automation of the mortgage evaluation process, improvements to the evaluation process of the property value, and improved investments on assets.

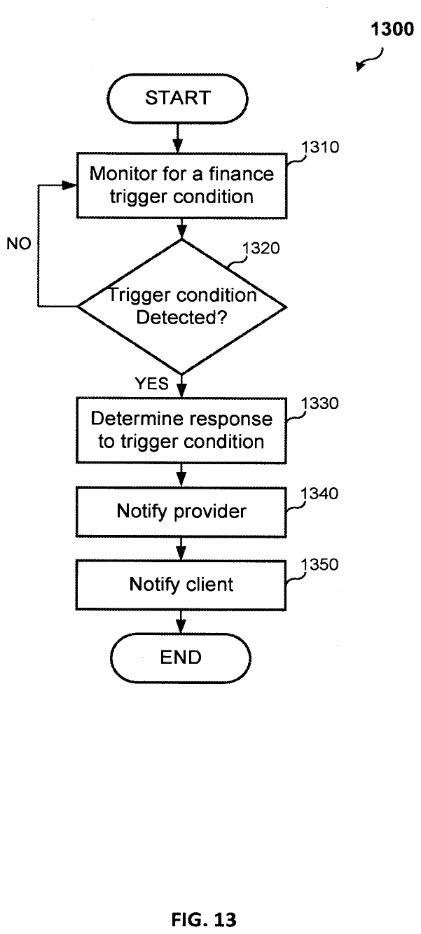

FIG. 13 is an exemplary flow diagram 1300 illustrating a method of monitoring a user's financial condition, according to an embodiment of the disclosure. The monitoring method may be performed by device 100A of FIG. 1. In some embodiments, it may be desirable to monitor a user's financial or other type of situation or condition to determine if a financial event such as a default on a mortgage may become more likely. In such scenario, it may be desirable to detect these conditions prior to their occurrence to take precautionary measures. Such precautionary measures may include a suitable response such as requesting additional contributions in capital to anticipate the likely default, alerting the user of the possible default and the detected trigger conditions. In some examples, the method may be based on a trained neural network such as network 440 of FIG. 4, e.g., with inputs as data 450 provided to the neural network 440 to derive an output 470 that is a response to the input.

The method may be methods of the clients from the devices such as device 100A or unit 152 or system 160 of FIG. 1, device 100D of FIG. 2, device 100E of FIG. 3, etc. Starting at step 1310, the method may include monitoring for a finance trigger condition. The method may include, at step 1320 detecting a trigger condition. A trigger condition may be any one or a set of events of changed attributes of the user including, for example, changes in income, career changes, family situations, credit score changes, etc. If a trigger condition is detected, the method may progress to step 1330. If a trigger condition is not detected, the method may return to step 1310 to continue monitoring for trigger conditions. In other embodiments, the method 1300 may end if no trigger condition is detected. The method, at step 1330, may determine a response if a trigger condition is detected. The response may be any one or more of a suitable response. The response may include, for example, requesting additional contributions in capital to anticipate a likely default on a loan, alerting the user of the possible default and the detected trigger conditions, etc. The method, at step 1340, may include notifying the provider (e.g., the provider of a mortgage loan to the user). Step 1340 may be option in some examples. The method, at step 1350, may include notifying the client (e.g., the mortgagor or borrower of a mortgage loan). For example, the method may include notifying the client of the precautionary measures to be taken. In some examples, additional steps may be provided if the precautionary measures require action be taken on the part of the client.

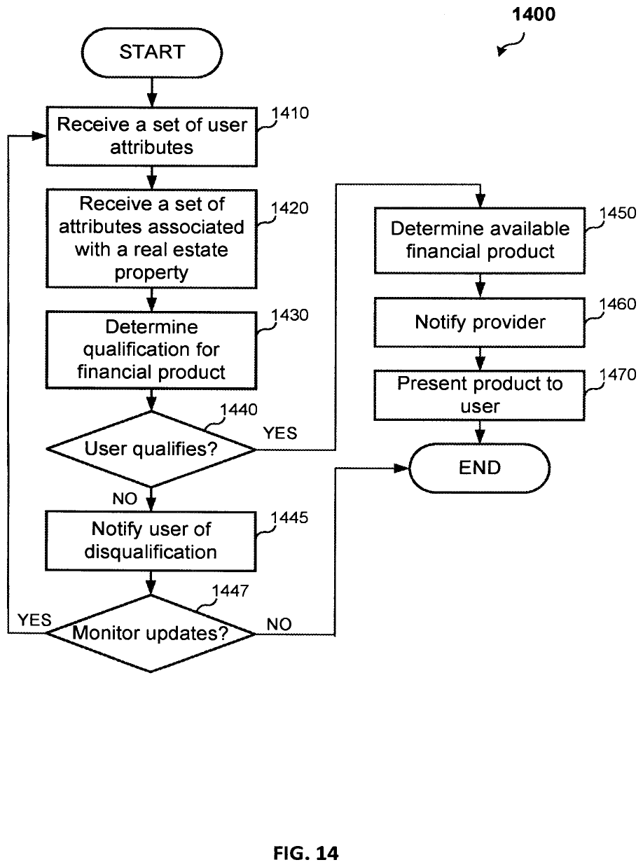

FIG. 14 is an exemplary flow diagram 1400 illustrating a method of determining available financial products, according to an embodiment of the disclosure. The method may be methods of the clients from the devices such as device 100A or unit 152 or system 160 of FIG. 1, device 100D of FIG. 2, device 100E of FIG. 3, etc. The method may include, at step 1410, receiving a set of user attributes. The method may include, at step 1420, receiving a set of attributes associated with a real estate property. The method may include, at step 1430, determining qualification for a financial product (e.g., a loan) based on the information of step 1420 and step 1430. The method may include, at step 1440, determining whether the user qualifies for one or more financial products. If the user qualifies for any one of the financial products, the method may proceed to step 1450. If the user does not qualify for at least one financial product, then the method may proceed to step 1445. The method may include, at step 1445, notifying the user of disqualification for a financial product. After step 1445, the method may include, at step 1447, determining whether to monitor for updates. In some examples, it may be desirable to monitor for updates (e.g., changes in the user and/or real estate property attributes) that could change the qualification outcome to the determination at step 1430. If no monitoring is desired, then the method may end. If monitoring is desired, then the process may return to step 1410 to restart the process. In other embodiments, if the monitoring is desired, the method may proceed to step 1430 (instead of to step 1410) to quickly reassess the user's qualification for the financial product.

Returning to step 1440, if the user qualifies then the method may proceed to step 1450. The method may include, at step 1450, determining the available financial products and suitable conditions for such financial products. The method may include, at step 1460, notifying the provider (e.g., the provider of a mortgage loan to the user). The method may include, at step 1470, presenting the product or products to the user. In some examples, additional steps may be provided to complete the process for providing the financial product or products to the user. For example, the user may need to tender additional information, sign forms and agreements, and make payments for the products. The method may end after step 1470.

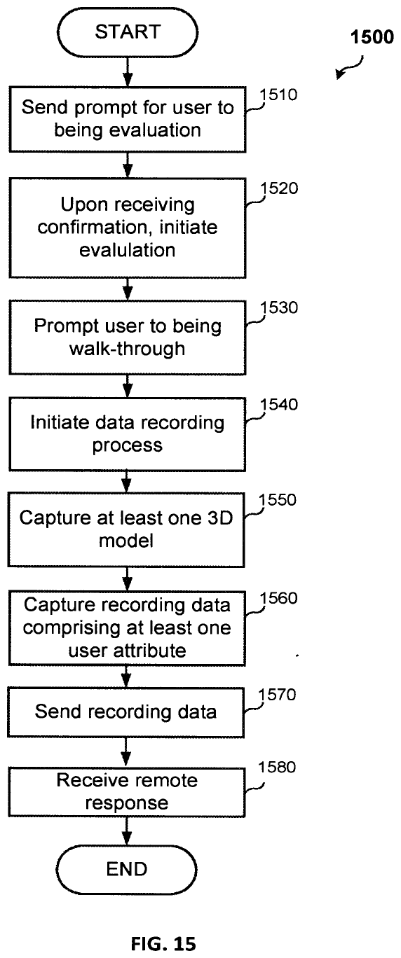

FIG. 15 is an exemplary flow diagram 1500 illustrating a method of the provision of financial services, according to an embodiment of the disclosure. The financial services device may be the device 100A of FIG. 1. The method may be methods of any of the system clients from the devices. Starting at step 1510, the method may include sending, to a display of the device, a prompt for a user to begin an on-location premises evaluation. For example, a user may be at a real estate property location that the user desires to purchase. At step 1520, the method may include upon receiving, from the user interface of the device, confirmation from the user to being the evaluation, initiating the on-location premises evaluation. At step 1530, the method may include prompting the user to begin a walk-through of a structure associated with the premises. At step 1540, the method may include initiating, at the device, a data recording process to capture at least one of a dimension measurement and imagery information of the premises. At step 1550, the method may include capturing at least one of a 3D model, a dimension measurement of the structure comprising at least one inside dimension and one outside dimension; at least one room quantity. At step 1560, the method may include capturing the recording data comprising at least one user attribute comprising at least one of a demographic and user preference attribute. At step 1570, the method may include sending, to a remote server, the recorded data. At step 1580, the method may include receiving, from the remote server, a response comprising at least one of a numerical assessed valuation.

Some portions of the detailed descriptions above may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “storing,” “detecting,” “retrieving,” “granting,” “performing,” “locking,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specifically constructed for the required purposes, or it may be general purpose computer system selectively programmed by a computer program stored in the computer system. Such a computer program may be stored in a computer readable storage medium, such as, but not limited to, any type of disk including optical disks, CD-ROMs, DVD-ROMs, Blu-ray disks, magnetic-optical disks, read-only memories (ROMs), random access memories (RAMs), EPROMS, EEPROMs, magnetic-optical disk storage media, optical storage media, flash memory devices, solid state devices, other type of machine-accessible storage media, or any type of media suitable for storing electronic instructions, each coupled to a computer system bus.

The algorithms and displays presented herein are not inherently related to any particular computer or other apparatus. In some embodiments various general-purpose systems may be used with programs in accordance with the teachings herein, or it may prove convenient to construct a more specialized apparatus to perform the required method steps. The required structure for a variety of these systems will appear as set forth in the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method implemented on an on-location premises evaluation device, the method comprising:
sending, to a display of the device, a prompt for a user to begin an on-location premises evaluation;
upon receiving, from the user interface of the device, confirmation from the user to being the evaluation, initiating the on-location premises evaluation;
prompting the user to begin a walk-through of a structure associated with the premises;
initiating, at the device, a data recording process to capture at least one of a dimension measurement and imagery information of the premises;
capturing at least one of a 3D model, a dimension measurement of the structure comprising at least one inside dimension and one outside dimension, or at least one room quantity;
capturing the recording data comprising at least one user attribute comprising at least one of a demographic and user preference attribute;
sending, to a remote server, the recorded data; and
receiving, from the remote server, a response comprising at least one of a numerical assessed valuation.

2. The method of claim 1, further comprising:
receiving, from the remote server, a preliminarily offer of a mortgage agreement based on the numerical assessed valuation and the least one of a demographic attribute and user preference attribute.

3. The method of claim 1, further comprising:
wherein prompting the user to begin the walk-through comprises a walk-through of an exterior and an interior of the premises, wherein the dimension measurement of the structure comprises at least one of an exterior or interior dimension measurement.

4. The method of claim 1, further comprising:
wherein the demographic attribute comprises at least one of an age, sex, education, or income and the user preference attribute comprises at least one of a minimum or maximum price, borrowing tolerance, time responsiveness preference, capturing the recording data comprising at least one user attribute further comprises capturing

5. The method of claim 1, wherein the on-location premises evaluation device comprises video input or audio input, and wherein receiving confirmation from the user comprises visual or audio confirmation from video input or audio input.

6. A method implemented on a server in communication with a remote on-location premises evaluation device, the method comprising:
receiving, from the remote on-location premises evaluation device, a request for a numerical assessed valuation associated with real property of the premises, wherein the request comprises at least one of: 1) at least one of a dimension measurement and imagery information of the premises, 2) a dimension measurement of the structure comprising at least one inside dimension and one outside dimension; at least one room quantity, 3) at least one user attribute comprising at least one of a demographic and user preference attribute;
determining, by querying a valuation data model, the numerical assessed valuation based on the request, wherein the data model comprises a sets of attributes associated with the request; and
sending, to the remote on-location premises evaluation device, the determined numerical assessed valuation.

7. The method of claim 6, further comprising:
receiving, from remote on-location premises evaluation device, a response comprising one of an acceptance or a rejection of the numerical assessed valuation.

8. The method of claim 6, wherein the request comprises data based on a walk-through of a structure associated with the premises.

9. The method of claim 6, further comprising:
sending a preliminarily offer of a mortgage agreement based on the numerical assessed valuation and the least one of a demographic attribute and user preference attribute.

10. The method of claim 6, wherein the demographic attribute comprises at least one of an age, sex, education, or income and the user preference attribute comprises at least one of a minimum or maximum price, borrowing tolerance, time responsiveness preference.
